(19) United States
(12) Patent Application Publication
(10) Pub. No.: US 2005/0016181 A1
(43) Pub. Date: Jan. 27, 2005

(54) Method and device for affecting thermoacoustic oscillations in combustion systems

(76) Inventors: Ephraim Gutmark, Cincinnati, OH (US); Christian Oliver Paschereit, Berlin (DE)

Correspondence Address: CERMAK & KENEALY LLP, P.O. BOX 7518, ALEXANDRIA, VA, 22307, US

(21) Appl. No.: 10/725,564

(22) Filed: Dec. 3, 2003

(30) Foreign Application Priority Data
Dec. 7, 2002 (DE) 102 57 245.3

(51) Int. Cl. F02C 6/04

(52) U.S. Cl. 60/784

(57) ABSTRACT

The present invention relates to a method and a device (1) for affecting thermoacoustic oscillations in a combustion system (5) comprising at least one burner (6) and at least one combustor (7),
a gas flow forming in the region of the burner (6) being excited acoustically and/or modulated injection of fuel being carried out. In order to improve the action of affecting the thermoacoustic oscillations, the acoustic excitations of the gas flow and/or the modulated injections of the fuel are coordinated in order to affect at least two different interference frequencies of the thermoacoustic oscillations.

### TECHNICAL FIELD

The invention relates to a method and a device for affecting thermoacoustic oscillations in a combustion system comprising at least one burner and at least one combustor, having the features of the preamble of claim 1 and having the features of the preamble of claim 7.

### PRIOR ART

It is known that undesired thermoacoustic oscillations frequently occur in combustors of gas turbines. The term “thermoacoustic oscillations” designates mutually self-reinforcing thermal and acoustic disruptions. In the process, high oscillation amplitudes can occur, which can lead to undesired effects, such as to high mechanical loading of the combustor, increased NOₓ emissions as a result of inhomogeneous combustion or even to the flame being extinguished. This applies in particular to combustion systems with little acoustic damping. In order to ensure a high output in relation to the pulsations and emissions over a wide operating range, active control of the combustion oscillations may be necessary.

In order to achieve particularly low NOₓ emissions, in modern gas turbines an increasing proportion of the air is led through the burner itself and the cooling air stream is reduced. Since, in conventional combustors, the cooling air flowing into the combustor has a sound-dampening effect and therefore contributes to the dampening of thermoacoustic oscillations, the sound damping is reduced by the aforementioned measures for reducing the NOₓ emissions.

EP 0 918 152 A1 discloses affecting thermoacoustic oscillations by the shear layer forming in the region of the burner being excited acoustically.

EP 0 985 810 A1 discloses the fact that thermoacoustic oscillations can be affected by modulated injection of liquid or gaseous fuel being carried out.

The known devices and methods are in each case coordinated to affect a specific interference frequency of the thermoacoustic oscillations. In specific applications, however, oscillation systems with a plurality of interference frequencies can also occur, it being possible in particular for the reduction in the disruptive effect of a main interference frequency to amplify the disruptive effect of a secondary interference frequency.

### SUMMARY OF THE INVENTION

This is the starting point for the invention. The present invention concerns the problem of indicating a way of improving the action of affecting thermoacoustic oscillations in a combustion system, the intention being in particular to make it possible to affect thermoacoustic oscillations with two or more interference frequencies.

According to the invention, the problem is solved by the subjects of the independent claims. Advantageous embodiments are the subject of the dependent claims.

The invention is based on the general idea of affecting a plurality of interference frequencies of the thermoacoustic oscillations separately. In this way, detrimental interactions which, when combating one interference frequency, can cause amplification of the other interference frequency, can be reduced or eliminated. It has been shown that, by means of the procedure according to the invention, at least the damping of the main interference frequency can be boosted considerably.

According to an advantageous embodiment, two interference frequencies can be affected exclusively by means of acoustic excitation of the gas flow with oscillations of different phases and/or amplitudes. In this embodiment, it is possible to dispense with modulated injection in order to affect two interference frequencies. In this case, the thermoacoustic oscillations are primarily affected in an acoustic way.

In an alternative development, two interference frequencies can be affected exclusively by means of modulated injection of the fuel with injection modulations with different injection times and/or injection quantities. As distinct from the aforementioned variant, in the case of this variant, acoustic excitation of the gas flow can be dispensed with. Accordingly, affecting the thermoacoustic oscillations here is carried out primarily via the fuel injection.

Furthermore, a solution is conceivable in which one interference frequency is affected by acoustic excitation of the gas flow while another interference frequency is affected by modulated injection of the fuel. In this variant, the two different affecting methods are combined with each other, in order to affect different interference frequencies with different methods. In the case of such a structure, it is possible in particular to fall back on the known systems mentioned at the beginning.

Further important features and advantages of the invention emerge from the subclaims, from the drawings and from the associated figure description using the drawings.

### BRIEF DESCRIPTION OF THE DRAWINGS

Preferred exemplary embodiments of the invention are illustrated in the drawings and will be explained in more detail in the following description, identical references designating identical or similar or functionally identical components. In the drawing, in each case schematically,

FIGS. 1 to 3 each show a highly simplified basic illustration of a device according to the invention in different embodiments.

### WAYS OF IMPLEMENTING THE INVENTION

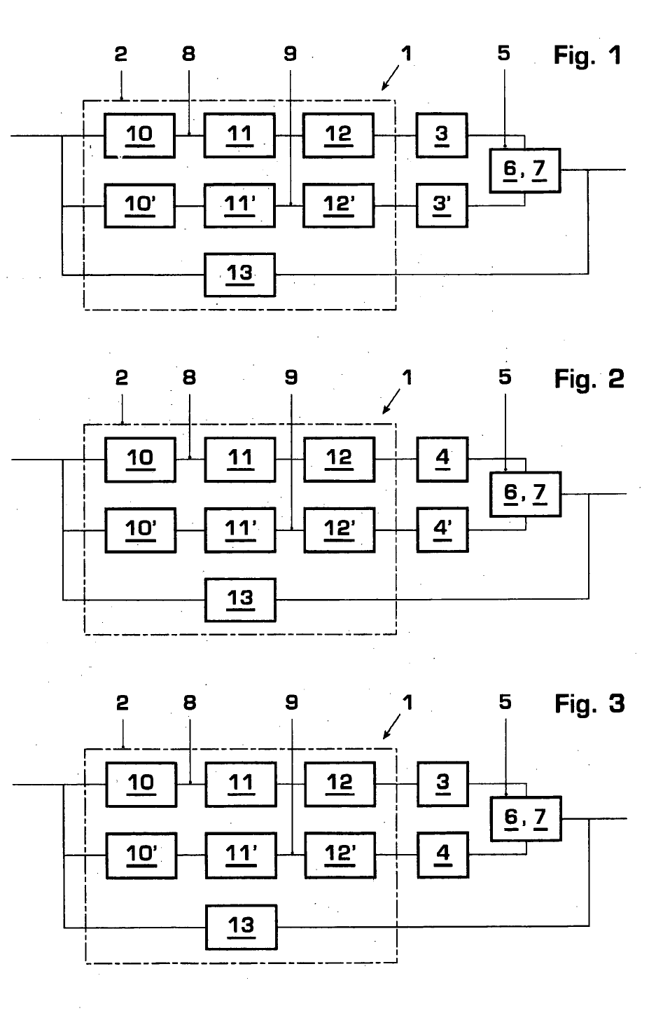

According to FIGS. 1 and 3, the device 1 according to the invention comprises a control system 2, which is merely symbolized here by a frame represented by broken lines. The device 1 additionally has at least one acoustic source 3 and/or at least one control valve 4 of a fuel supply device, otherwise not shown. The device 1 is associated with a combustion system 5, which normally has at least one burner 6 and at least one combustor 7. For simplification, here the burner 6 and combustor 7 are symbolized by a common rectangle.

The exemplary embodiments shown here differ from one another essentially in the fact that, in the variant according to FIG. 1, the control system 2 drives two separate acoustic sources 3, while, in the variant according to FIG. 2, it drives two separate control valves 4 and, in the variant according to FIG. 3, it drives one acoustic source 3 and one control valve 4. If there are two acoustic sources 3, one of them is designated 3′. In a corresponding way, one of the control valves 4 is designated 4′ if two control valves 4 are provided.

For this purpose, the control system 2 in each case contains two control paths 8 and 9 which, on the input side, each contain a frequency band-pass filter 10. Since the two frequency band-pass filters 10 are tuned to different interference frequencies, one frequency band-pass filter is designated 10′. In the control paths 8, 9, in each case a time delay element 11 or 11′ is connected downstream of the frequency band-pass filter 10, 10′ and, in turn, an amplifier element 12 is connected downstream of said time delay elements. On the output side, the two control paths 8, 9 are connected either to one of the acoustic sources 3 or to one of the control valves 4.

Furthermore, each control system 2 contains a control algorithm 13 which, on the basis of incoming signals, outputs appropriate signals to the input sides of the control paths 8, 9. The control algorithm 13 receives its input signals from sensors, not shown here, which are designed to measure thermoacoustic oscillations in the combustion system 5. The signals determined by the sensors in this case correlate with the thermoacoustic oscillations in the combustion system 5. The measured signals can be pressure signals in this case. The sensors then comprise pressure sensors, preferably microphones, in particular water-cooled microphones and/or microphones with piezoelectric pressure sensors. It is likewise possible for the signals measured by the sensors to be formed by chemiluminescence signals, preferably by chemiluminescence signals from the emission of one of the radicals OH or CH. The sensors can then expediently have optical sensors for visible or infrared radiation, in particular optical fiber probes.

The pressure or luminescence signal measured in the combustor 7, for example, is filtered in the frequency band-pass filters 10, 10′. By means of the different forward frequencies of the frequency band-pass filters 10, 10′, the desired separate action of affecting two different interference frequencies, for example a main interference frequency and a secondary interference frequency, of the thermoacoustic oscillations in the combustion system 5 is made possible. In the respective control path 8, 9, a phase shift is then made in the respective time delay element 11, 11′, it being possible for the phase shifts in the control paths 8, 9 to be different.

Signal amplification is then carried out in the amplifier 12, it being possible here, too, for the amplification in the control paths 8, 9 to be different in order to produce different amplitudes. The signals emerging from the control paths 8, 9 then drive the respective acoustic source 3, 3′ or the respective control valve 4, 4′. This results in the desired action of affecting the thermoacoustic oscillations.

The control system 2, in particular its control algorithm 13, can actuate the time delay elements 11 and 11′ and/or the amplifiers 12 as a function of the instantaneous pressure or luminescence signals. In this way, the influence of the respective control path 8, 9 on the respectively assigned interference frequency can be varied or tracked. To this extent, the result is closed control loops for both control paths 8, 9.

For the functioning of affecting the thermoacoustic oscillations by means of acoustic excitation of the gas flow, reference is made to EP 0 918 152 A1, whose content is hereby incorporated in the disclosure content of the present invention by express reference. In a corresponding way, for the functioning of affecting the thermoacoustic oscillations by means of modulated fuel injection, reference is made to EP 0 985 810 A1, whose content is hereby incorporated in the disclosure content of the present invention by express reference.

The mechanical fluidic stability of a gas turbine burner is of critical importance for the occurrence of thermoacoustic oscillations. The mechanical fluidic instability waves arising in the burner lead to the formation of vortices. These vortices, also referred to as coherent structures, play an important role in mixing processes between air and fuel. The spatial and temporal dynamics of these coherent structures affect the combustion and the liberation of heat. As a result of the acoustic excitation of the gas flow, the formation of these coherent structures can be counteracted. If the production of vortex structures at the burner outlet is reduced or prevented, then the periodic fluctuation in the liberation of heat is also reduced thereby. These periodic fluctuations in the liberation of heat form the basis for the occurrence of thermoacoustic oscillations, however, so that, by means of the acoustic excitation, the amplitude of the thermoacoustic oscillations can be reduced.

It is of particular advantage in this case if, in order to affect the thermoacoustic oscillations, a shear layer forming in the region of the burner is excited acoustically. Here, shear layer designates the mixing layer which forms between two fluid flows of different velocities. Affecting the shear layer has the advantage that excitations introduced into the shear layer are amplified. Thus, only a little excitation energy is needed in order to extinguish an existing sound field. As distinct from this, in the case of a pure anti-sound principle, an existing sound field is extinguished by means of a phase-shifted sound field of the same energy.

The shear layer can be excited both downstream and upstream of the burner. Downstream of the burner, the shear layer can be excited directly. In the case of excitation upstream of the burner, the acoustic excitation is initially introduced into a working gas, for example air, the excitation then being transmitted through the burner into the shear layer after passing through the working gas. Since only low excitation powers are necessary, the acoustic sources 3 can be formed by acoustic drivers, for example loudspeakers, which are aimed at the gas flow. Alternatively, one or more chamber walls can be excited mechanically to oscillate at the respectively desired frequency.

The instantaneous acoustic excitation of the gas flow or its shear layer is preferably phase-coupled with a signal which is measured in the combustion system and which is correlated with the thermoacoustic fluctuations. This signal can be measured downstream of the burner in the combustor or in a quietening chamber arranged upstream of the burner. The instantaneous acoustic excitation is then controlled as a function of this measured signal.

By selecting a suitable phase difference, which differs depending on the type of measured signal, between the measured signal and instantaneous acoustic excitation signal, the acoustic excitation counteracts the formation of coherent structures, so that the amplitude of the pressure pulsation is reduced. The aforementioned phase difference is set by the respective time delay element 11, 11′ and takes account of the fact that phase shifts generally occur as a result of the arrangement of the measuring sensors and acoustic drivers or sources 3, 3′ and control valves 4, 4′ and as a result of the measuring instruments and lines themselves. If the set relative phase is selected such that the result is the greatest possible reduction in the pressure amplitude, all these phase-rotating effects are implicitly taken into account. Since the most beneficial relative phase can change over time, the relative phase advantageously remains variable and can be tracked, for example via monitoring the pressure fluctuations, so that high suppression is always ensured.

With the aid of modulated fuel injection, the formation of thermoacoustic oscillations can be affected. In this case, modulated fuel injection is understood to mean any time-varying injection of liquid or gaseous fuel. This modulation can be carried out, for example, at any desired frequency. The injection can be carried out independently of the phase of the pressure oscillations in the combustion system; however, an embodiment is preferred in which the injection is phase-coupled to a signal which is measured in the combustion system 5 and is correlated with the thermoacoustic oscillations. The modulation of the fuel injection is carried out by means of appropriate opening and closing of the control valves 4, 4′, by which means the injection times (start and end of the injection) and/or the quantity injected are varied. As a result of the modulated fuel supply, the quantity of fuel converted into large-volume vortices can be controlled. In this way, the formation of the coherent liberation of heat and thus the production of thermoacoustic instabilities can be affected.

In the embodiment according to FIG. 1, two separate acoustic sources 3 and 3′ are shown, which are driven separately via the parallel control paths 8, 9. In principle, an embodiment in which both control paths 8, 9 are connected to a common acoustic source is conceivable, the output signals from the control paths 8, 9 then being superimposed in an appropriate way.

The same is also true of the embodiment according to FIG. 2, in which two separate control valves 4 and 4′ are driven by the two control paths 8, 9. Here, too, it is in principle conceivable to drive a common control valve by superimposing the output signals from the two control paths 8, 9 in order to affect the two interference frequencies.

### List of References

1 device
2 control system
3 acoustic source
4 control valve
5 combustion system
6 burner
7 combustor
8 control path
9 control path
10 frequency band-pass filter
11 time delay element
12 amplifier
13 control algorithm

1. A method for affecting thermoacoustic oscillations in a combustion system having at least one burner and at least one combustor, in which a gas flow forming in the region of the burner is excited acoustically, in which modulated injection of fuel is carried out or both, the method comprising:
coordinating the acoustic excitations of the gas flow, the modulated injections of the fuel, or both, to affect at least two different interference frequencies of the thermoacoustic oscillations.

2. The method as claimed in claim 1, comprising:
affecting two interference frequencies exclusively by acoustic excitation of the gas flow with different phases, amplitudes, or both.

3. The method as claimed in claim 2, comprising:
producing the acoustic excitation of the gas flow with at least one acoustic source, said producing including producing acoustic excitations of different phases, amplitudes, or both, via a common acoustic source or via at least two separate acoustic sources.

4. The method as claimed in claim 1, comprising:
affecting two interference frequencies exclusively by modulated injections of fuel with different injection times, different injection quantities, or both.

5. The method as claimed in claim 4, comprising:
producing modulated injections of the fuel with at least one control valve, the modulated injections with different injection times, different injection quantities, or both, being carried out via a common control valve or via at least two separate control valves.

6. The method as claimed in claim 1, comprising:
affecting one interference frequency by acoustic excitation of the gas flow; and
affecting another interference frequency by modulated injection of the fuel.

7. A device for affecting thermoacoustic oscillations in a combustion system comprising:
at least one burner and one combustor;
at least one acoustic source configured and arranged to produce acoustic excitation of a gas flow forming in the region of the burner, burner having at least one fuel supply device with at least one control valve for producing modulated injection of a fuel, or both;
a control system driving the at least one acoustic source, the at least one control valve, or both, to affect at least two different interference frequencies of the thermoacoustic oscillations.

8. The device as claimed in claim 7, wherein the control system has a control path for each interference frequency to be affected, which, on an input side, has a frequency band-pass filter tuned to the respective interference frequency and, on an output side, is connected to the respective acoustic source or to the respective control valve, each control path containing a time delay element.
